(19) United States
(12) Patent Application Publication
(10) Pub. No.: US 2007/0273658 A1
(43) Pub. Date: Nov. 29, 2007

(54) Cursor actuation with fingerprint recognition

(75) Inventors: Jyrki Yli-Nokari, Tampere (FI); Mika P. Tolvanen, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/441,528

(22) Filed: May 26, 2006

(51) Int. Cl. G06F 3/041

(52) U.S. Cl. 345/173

(57) ABSTRACT

A method for controlling a graphical display receives a user input at a touch-sensitive user interface. Responsive to receiving that user input, a user is automatically recognized from biometric data gathered at that touch-sensitive user interface, such as by comparison to a locally stored database of authorized users. A visual cursor at a graphical display is then automatically activated. The visual cursor is removed from the graphical display when the user input is no longer received at the touch-sensitive user interface. So long as the visual cursor is not removed and after user authentication, movement of the visual cursor at the graphical display is made to correspond with movement sensed at the touch-sensitive user interface.

### TECHNICAL FIELD

The present invention relates to electronic user interfaces having a graphical display, and particularly relates to actuating a graphical cursor in relation to fingerprint recognition of a user.

### BACKGROUND

In an electronic device such as a mobile station or any computing device that uses a visual display, there are tradeoffs between capabilities that may be made into the device and usability for the end user. A particular concern with multi-functional or portable computing devices is the limited area for visual display and often a limited number of distinct keys at a keypad interface (e.g., less than a full QWERTY keyboard). While advances in software, computer readable storage media, and computer processing enable more functionality in smaller and more reliable devices, such functionality must be readily adoptable by and intuitive to a user in order to add value to the device.

The visual display cursor is a particularly intuitive user interface tool, moving across a display screen according to a user's motions entered via a computer mouse or touch pad (also known as a glide pad). It is known to add a security feature to the touchpad embodiment, where the touchpad is adapted to sense and recognize a user's fingerprint. Examples of this may be seen at U.S. Pat. No. 6,400,836 B2 to A. W. Senior, which describes regularly scanning fingerprints acquired from a pointing device touch pad by a system that determines six degrees of freedom, enabling a user to manipulate a three-dimensional model of a virtual reality system. Another example is U.S. Pat. No. 6,337,918 B1 to S. D. Holehan, which describes a personal computer touchpad having an infrared source and detector to implement fingerprint security and/or cursor control. Still further, U.S. Pat. Nos. 6,392,636 B1 to Ferrari et al., and 6,650,314 B2 to L. Philipson, describes cursor positioning on a display in response to a user input on a pointing device. Each of these is incorporated by reference for their technical features.

Portable devices that generally exhibit smaller display screens, as well as any multi-functional computing device, impose an added tradeoff of determining what to display and what to remove. While it is technically feasible to display a multitude of disparate items corresponding to active and latent actions and applications running at a particular time, after only a few open applications the screen would become filled with items not in the forefront of the user's current mental activities, and the display becomes less relevant to the user because the valid information s/he seeks lies among multiple visual stimuli on a small display screen rather than prominently dominating the display as the expense of less relevant information. The display becomes less intuitive because it is cluttered with information not presently relevant to the user.

What is needed in the art are further refinements to the correspondence between entries at a touch pad and display at a graphical interface so that the displayed material remains relevant to a current user's actions. The solution described herein has broad applications for any computing device that uses a graphical display and a touch-sensitive interface.

### SUMMARY

The foregoing and other problems are overcome, and other advantages are realized, in accordance with the invention disclosed herein and its various illustrative embodiments. The term “touch-sensitive” interface is not limited to pressure sensitive interfaces; various and multiple other embodiments are presented within the regime of what an objective user would perceive as being “touch-sensitive”.

In accordance with one aspect, the invention is a method for controlling a graphical display. In the method, a user input is received at a touch-sensitive user interface. Responsive to receiving that user input, a user is automatically recognized from biometric data gathered at the touch-sensitive user interface. A visual cursor at a graphical display user interface is then automatically activated. The visual cursor is removed from the graphical display when a user input is no longer sensed at the touch-sensitive user interface.

In accordance with another aspect, the present invention is a program of machine-readable instructions, tangibly embodied on an information bearing medium and executable by a digital data processor, to perform actions directed toward actuating a cursor in correspondence with a user input. In this embodiment, the actions include determining that a user initiates contact with a touch sensitive interface, and then gathering user biometric data from the touch-sensitive interface. From the biometric data, it is determined whether the user is authorized. Only if the user is authorized, then the following steps occur. A visual cursor is activated at a graphical display interface; movement is sensed at the touch-sensitive interface and the visual cursor is moved in correspondence with that sensed movement. Also, it is continuously or periodically determined whether the user remains in contact with the touch-sensitive interface. When it is determined that the user no longer remains in contact with the touch-sensitive interface, the visual cursor is removed from the graphical display interface.

In accordance with another aspect, the present invention is a computing device that includes a touch-sensitive interface, a graphical display screen, a computer readable medium, and a processor coupled to each of the above components. The touch-sensitive interface is adapted to gather user biometric data. The computer readable medium stores user biometric data. The processor is for comparing user biometric data gathered at the touch-sensitive user interface to the stored user biometric data, and for initiating display of a cursor at the graphical display screen if the comparing is positive. The processor further is for continuously or periodically determining that an authorized user remains in contact with the touch-sensitive user interface. When the processor determines that the user no longer remains in contact with the touch-sensitive user interface, it disables the display of the cursor at the graphical display screen.

Further details as to various embodiments and implementations are detailed below.

### BRIEF DESCRIPTION OF THE DRAWINGS

The foregoing and other aspects of these teachings are made more evident in the following Detailed Description, when read in conjunction with the attached drawing figures that serve as non-limiting examples.

FIG. 1 is a schematic diagram of certain internal components of a mobile station according to an embodiment of the invention.

FIG. 2 is a schematic diagram showing external components of the mobile station of FIG. 1.

FIGS. 3A-3F illustrate various user inputs at a touch sensitive display and the corresponding response at the graphical display according to an embodiment of the invention.

FIG. 4 is a process flow diagram illustrating steps in executing an embodiment of the present invention.

### DETAILED DESCRIPTION OF EMBODIMENTS OF THE INVENTION

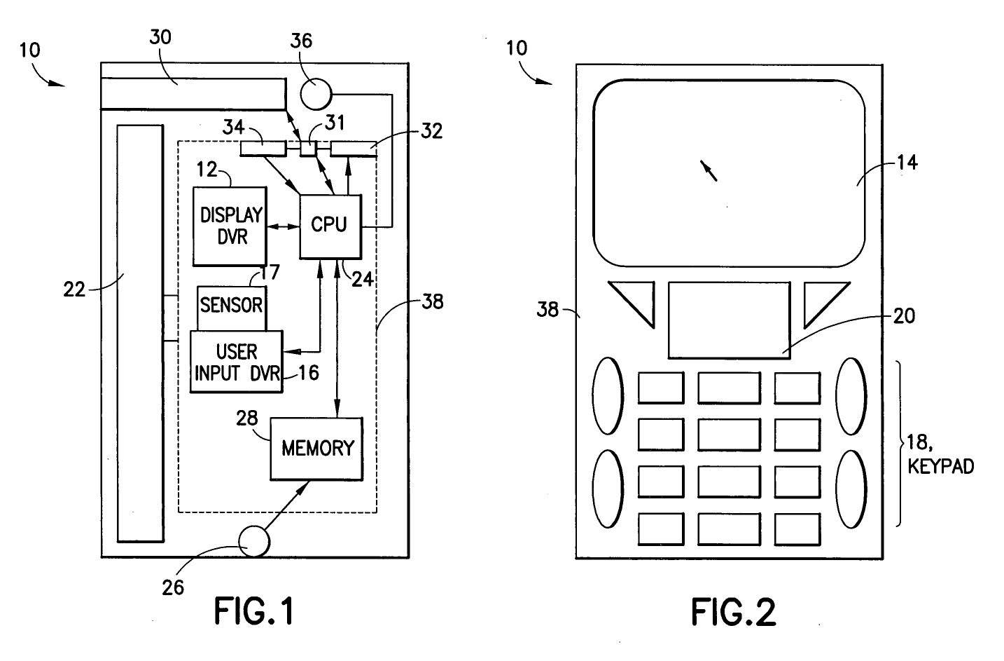

FIGS. 1 and 2 are different schematic views of a mobile station MS 10 in which the present invention may be embodied. The present invention may be disposed in any host computing device having a graphical display element and a touch sensitive user interface (which are generally different entities but which may be combined into one), whether or not the device is mobile, whether or not it is coupled to a cellular of other data network or even capable of communicating with other devices via a network. A MS 10 is a handheld portable device that is capable of wirelessly accessing a communication network, such as a mobile telephony network of base stations that are coupled to a publicly switched telephone network. A cellular telephone, a portable e-mail device, a personal digital assistant (PDA) and a gaming device, each with Internet or other wireless two-way communication capability, are examples of a MS 10.

The component blocks illustrated in FIGS. 1 and 2 are functional and the functions described below may or may not be performed by a single physical entity as described with reference to those Figures. A display driver 12, such as a circuit board with logic for driving a graphical display 14, and an input driver 16, such as an application specific integrated circuit ASIC for converting inputs from user actuated buttons arrayed in a keypad 18 and a touch-sensitive user interface 20 to electrical signals, are provided with the graphical display 14 and buttons 18/touch pad 20 for interfacing with a user. The display driver 12 (or alternatively the user input driver 16) may also convert user inputs at the graphical display 14 when that display screen 14 is touch sensitive, as known in the art. A sensor 17 forms part of the user input driver 16 and touch-sensitive interface 20 for converting user inputs into electrical signals. The sensor 17 may be optical as in an infrared source and detector, electrical as in an array of pressure sensitive points or areas or a charge coupled device CCD, or thermal as in an array of thermocouples that sense a user's touch. The MS 10 further includes a power source 22 such as a self-contained battery that provides electrical power to a micro-processor 24 that controls functions within the MS 10. Within the processor 24 are functions such as digital sampling, decimation, interpolation, encoding and decoding, modulating and demodulating, encrypting and decrypting, spreading and despreading (for a CDMA compatible MS 10), and additional signal processing functions known in the art.

Voice or other aural inputs are received at a microphone 26 that may be coupled to the processor 24 through a buffer memory (shown generally as being within the memory 28). Computer programs such as algorithms to modulate, encode and decode, data arrays such as look-up tables, and the like are stored in a main memory storage media 28 which may be an electronic, optical, or magnetic memory storage media as is known in the art for storing computer readable instructions, programs and data. The memory 28 is typically partitioned into volatile and non-volatile portions, and is commonly dispersed among different physical storage units. Some of those physical storage units may be removable, others may be dedicated to a specific function (as on an ASIC), and others may be a main memory that is partitioned for multiple purposes. The MS 10 communicates over a network link such as a mobile telephony link via one or more antennas 30 that may be selectively coupled via a transmit/receive switch or a diplex filter 31 to a transmitter 32 and to a receiver 34. The MS 10 may additionally have secondary transmitters and receivers for communicating over additional networks, such as a WLAN, WIFI, Bluetooth®, or to receive digital video broadcasts. Known antenna types include monopole, di-pole, planar inverted folded antenna PIFA, and others. The various antennas may be mounted primarily externally (e.g., whip) or completely internally of the MS10 housing 38 as illustrated. Audible output from the MS 10 is transduced at a speaker 36. Most of the above-described components, and especially the processor 24, are disposed on a main wiring board 38, which typically includes a ground plane (not shown) to which the antenna(s), battery, and various other components are electrically coupled and grounded. Particular aspects of the invention are described below with respect to the touch sensitive user interface 20 and the graphical display screen 14. The processor 24 and the memory 28 are also employed in embodiments of the invention. As illustrated (FIG. 2), the surfaces of the touch-sensitive user interface 20 and the graphical display screen 14 form an exterior surface of the device 10 along with the housing.

In accordance with embodiments of the invention, a cursor at the graphical display user interface 14 is controlled by user inputs at the touch-sensitive user interface 20, conditional on biometric data gathered at the touch-sensitive user interface 20 matching an authorized user. The term cursor is used consistent with its ordinary meaning relevant to the computer display arts: an indicator movable across a display screen in conjunction with a user's fluid movement at an input device that visually shows a position at which some action will be taken, where that action is initiated at a user interface differently than merely moving the cursor. For example, a cursor in a text document typically moves about the screen in correspondence with movement of a mouse or trackball, and a text insert position indicator is moved to the current cursor position when a computer mouse button is clicked. Specifically, a user input is received at a touch-sensitive user interface such as the semiconductor fingerprint sensor described in U.S. Pat. No. 4,353,056 to Taikoe, or that may be readily adapted from the POS terminal SmartPad available through SmartTouch Inc. of Berkeley, Calif. The touch sensitive user interface 20 gathers biometric data, and compares that gathered biometric data with user authentication data stored in a memory 28. Related teachings in this regard may be found at U.S. Pat. No. 5,420,936 to Fitzpatrick et al. Both of the two references immediately above are incorporated by reference. If the comparison shows that an authorized user is operating the touch-sensitive pad 20, a visual cursor is automatically displayed at the graphical display user interface 14. The visual cursor is automatically removed once the mobile station no longer senses the authorized user at the touch sensitive user interface 20.

The biometric data is preferably a finger image. Known methods to gather finger image data from a touch-sensitive user interface include heat differentiation of the ridges and valleys of a user's fingertip, and optical imaging of the user's fingerprint or finger image such as by an IR source and detector, thermocouples, or a CCD. Comparison against a database of authorized users is readily executed by a processor, especially in embodiments where only a small number of authorized users are stored in the database against which a sensed finger image is compared. It is anticipated that portable electronic device embodiments will generally exhibit a small number of authorized users so their more limited processing power will not slow authentication. Better resolution may be obtained by disposing two image sensors, preferably at right angles to one another for improved two-dimensional resolution of the user's biometric data.

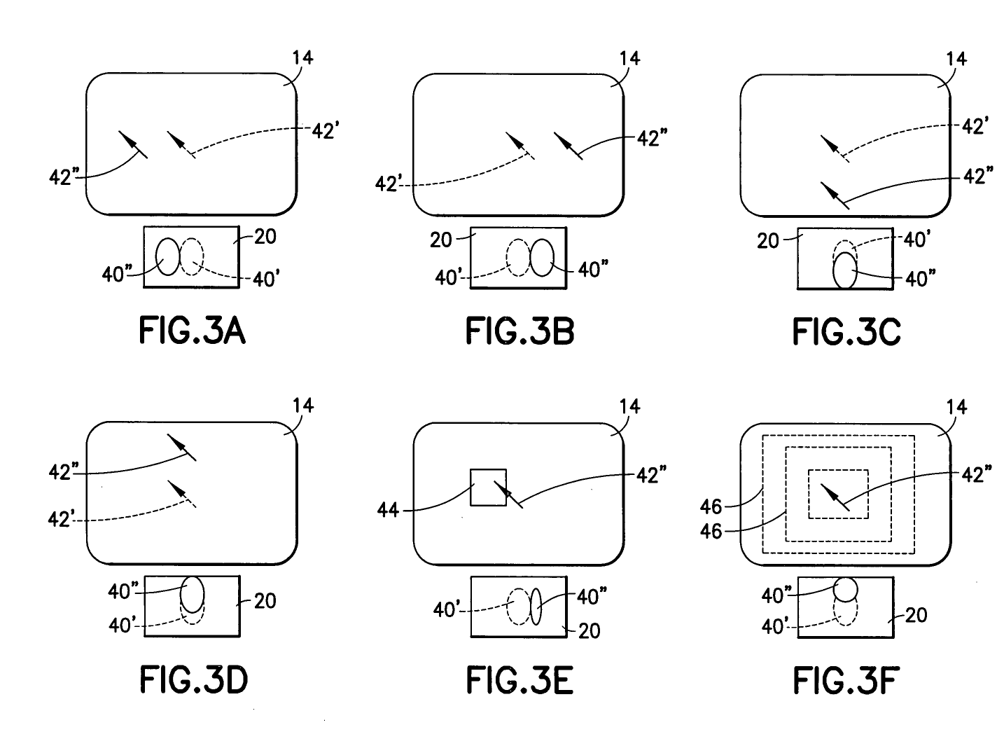

FIGS. 3A-3F illustrate the concept with more specificity. In each of those figures, the dashed oval indicated by reference number 40′ indicates an immediately previous position of an authorized user's finger on the touch-sensitive user interface 20, and the solid oval indicated by reference number 40″ indicates a current position of the authorized user's finger on that interface 20. Similarly, the muted cursor indicated by reference number 42′ indicates an immediately previous position of a visual cursor on the graphical display interface 14, and the bolded cursor indicated by reference number 42″ indicates a current position of the cursor on that graphical display interface 14. In practice, only one cursor 42″ is displayed at any given instant, though a ‘trace’ of immediately past cursor positions may remain for a fleeting time on the graphical display screen, as is currently possible with both Windows® and Mac® operating systems.

FIGS. 3A and 3B illustrate movement in the horizontal direction. In FIG. 3A, the authorized user moves his finger from a previous position 40′ toward the left of the touch-sensitive pad 20 to a current position 40″, and the cursor at the graphical display moves in correspondence from a previous position 42′ leftward to its current position 42″. In FIG. 3B, the authorized user moves his finger from a previous position 40′ toward the right of the touch-sensitive pad 20 to a current position 40″, and the cursor at the graphical display 14 moves in correspondence from a previous position 42′ rightward to its current position 42″.

FIGS. 3C and 3D illustrate movement in the vertical direction. In FIG. 3C, the authorized user moves his finger from a previous position 40′ downwards across the touch-sensitive pad 20 to a current position 40″, and the cursor at the graphical display 14 moves in correspondence from a previous position 42′ downwards to its current position 42″. In FIG. 3D, the authorized user moves his finger from a previous position 40′ upwards across the touch-sensitive pad 20 to a current position 40″, and the cursor at the graphical display 14 moves in correspondence from a previous position 42′ upwards to its current position 42″.

FIGS. 3E and 3F illustrate that the touch-sensitive user interface 20 may also sense movements other than linear sweeps of a user's finger position in order to perform other functions apart from moving the cursor. For example, FIG. 3E illustrates an authorized user moving his finger from a previous position 40′ in a sideways rolling motion along the touch-sensitive pad 20 to a current position 40″. The touch-sensitive user interface 20 senses that sideways rolling motion in that the finger image it senses over time is not swept across the touch sensitive user interface 20, but rather the ridges and valleys of the user's finger image remain stationary on the interface 20 and are lowered to or raised from it in a rolling motion. In the illustration of FIG. 3E, the sideways rolling motion causes a data field (e.g., application icon, text) that is immediately “underneath” or coincident on the graphical display screen 14 with the cursor 42″ to be selected 44. As is common for a select command, this is illustrated in FIG. 3E as being highlighted on the display 14. The select command is analogous to a single click of a traditional computer mouse or a single tap of a conventional touch-pad; an icon or text filed is captured but no other action is taken by the computing device. In FIG. 3F, the illustrated upwards rolling motion of a user's finger from the previous position 40′ on the touch-sensitive pad 20 to a current position 40″ is sensed as a different rolling motion as compared to FIG. 3E. This vertical rolling motion then results in executing 46 the data field that is coincident on the display screen 14 with the cursor 42″. An execute command is illustrated in FIG. 3F as an expanding box, representing an icon underneath the cursor 42″ being expanded to a larger size on the graphical display screen 14 when the computer program application associated with that icon is opened (e.g., MSWord® is opened when an execute command is imposed on an icon representing a document in the MSWord® format). The execute command is analogous to double-clicking on a traditional computer mouse or double tapping on a traditional touch-pad. Alternatively, a certain portion of the touch-sensitive user interface 20 may be reserved for a select or execute command, or one user's finger may be used to actuate cursor movement and a different finger may be recognized to actuate a select or execute command.

As detailed above, when the user is authenticated, the cursor 42 is enabled to follow the user's commands sensed at the touch sensitive user interface 20. When the user is not authenticated, the cursor is not so enabled and is not visible on the display 14. This may be embodied in various ways. As above, the cursor alone could be inhibited from appearing on the graphical display screen 14, and all functions related to the cursor (e.g., select, execute) are similarly inhibited, while other items such as icons may be visible and displayed on the graphical display 14. Alternatively, the entire graphical display 14 may be disabled so that no data is displayed (e.g., icons, links, etc.) when a user is not authenticated. In this latter embodiment, the entire graphical display 14 remains blank until a user is authenticated. All other user input devices such as the keypad 18 or microphone 26 (e.g., voice-activated functions for which the device 10 may be capable, such as dialing via a voice tag prompt) may also be inhibited when a user is not authenticated at the touch-sensitive interface 20. Once the user is authenticated, the cursor is displayed with other objects on the graphical display 14. There is a distinct advantage in blanking the entire graphical display 14 when a user is not authenticated, in that the security implementation may be entirely within the display driver 12. This is a highly secure option because the display driver 12 is typically a separate component isolated from others. Even better security can be obtained by bundling all input and output device drivers (such as keyboards, voice activation, touch screen and display) to one logical component and implementing the fingerprint security only within software that drives that logical component without external interfaces, and storing that software in read-only memory. Some intermediate implementations are also within the invention, such as enabling the graphical display 14 only when there is an incoming call when a user is not currently authenticated, and disabling the graphical display for all other purposes (as well as all user interfaces) when a user has not been authenticated. Of course, the touch sensitive user interface 20 would be enabled at all times for the limited purpose of sensing a user's finger image and testing it for authentication purposes.

While not specifically illustrated, it is a feature of embodiments of the invention that once the authorized user's finger image is no longer sensed at the touch-sensitive user interface 20, the cursor 42 is automatically removed from view on the graphical display interface 14. This is particularly advantageous in portable electronic devices whose graphical display interface 14 is size-limited by the size of the overall portable device. Removing the cursor 42 at those times enables more user-relevant data to be shown in the foreground of the display. Thus, recognition of the authorized user's finger image at the touch-sensitive user interface 20 activates the cursor, and removal of the authorized user's finger from the touch-sensitive user interface 20 disables the cursor from being displayed at the graphical display screen 14, either immediately or after some predetermined timeout period.

This is particularly advantageous when using a pen pointer, because the cursor corresponding to an authorized user's finger image can be readily made to be visually distinct on the graphical display screen 14 as compared to a cursor corresponding to the pen pointer. A digital pen pointer, such as Logitech's “io pen” or Seiko's “inklink”, enter either handwriting or handwriting that is converted to editable text into a computer and display it on a graphical display screen. For example, Seiko's SmartPad2 records editable text onto a personal digital assistant PDA. The touch-sensitive user interface 20 and/or the display screen 14 may be adapted as digital “paper” which recognizes movement of the pen pointer as handwriting and enters either that handwriting or text converted from that handwriting into the memory 28, which is simultaneously displayed on the graphical display 14. Further, removing the cursor actuated by the finger image at the touch-sensitive pad 20 upon removal of the authenticated user's finger from the pad 20 allows for a less cluttered graphical display 14 so that the pen pointer or other display screen navigation device is more prevalent to a user.

User authentication by the touch-sensitive interface 20 may be used to automatically log on an authorized user and to impose a mandatory security regime on the hosting electronic device. The user authentication may be performed once each time a finger is placed oil the touch-sensitive user interface 20, with authentication lost anytime an authorized user's finger is removed. Power considerations, especially in a portable device, tend to favor embodiments where either the user is authenticated only upon initial sensing at the touch-sensitive user interface 20, or periodically such as every few seconds. Less power intensive means such as pressure, optics, or non-imaging heat sensing can be used to verify continuous (or nearly continuous) contact of a user's finger to the touch-sensitive screen 20 in order to maintain logon of an authorized user and continuous display of the cursor 42 on the graphical display screen 14.

Certain aspects of the cursor might also be adapted to the user's specific actions at the touch-sensitive interface 20. In one embodiment, the initial position of the cursor when a user is first authenticated may be set to the center of the display screen 14, or may be set to a position corresponding to the relative position of the user's fingertip on the touch-sensitive interface 20. In another embodiment, the software may be adapted so that if the user removes his finger from the touch-sensitive interface 20 and returns it again within a predetermined time period, the cursor returns to its last position on the display screen 14. In this embodiment, the user will typically be re-authenticated by finger image recognition, but in certain embodiments this need not be necessary if the user's finger is off the touch-sensitive interface 20 for less than an elapsed period of time at which the device requires re-authentication. In another embodiment, the cursor may be adapted to gradually fade from the display screen 14 when the user is no longer sensed at the touch-sensitive interface 20.

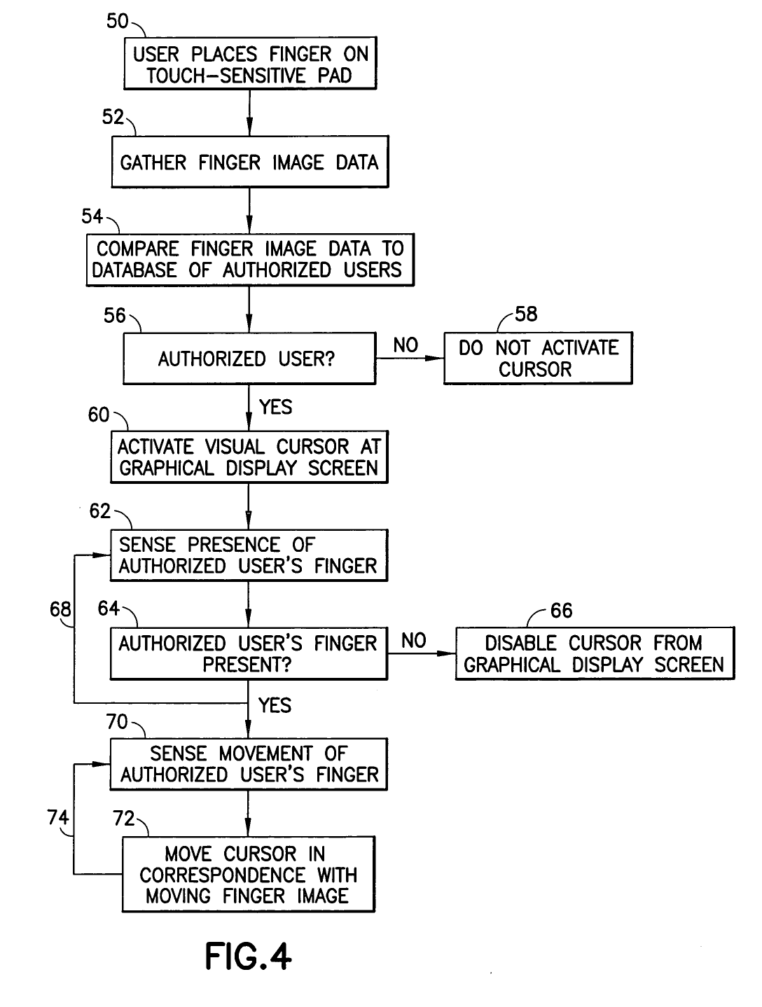

FIG. 4 illustrates process steps according to an embodiment of the invention. To assure that the invention is not limited to a portable device, FIG. 4 is detailed with respect to process steps executed by a generic computing device. The process begins at block 50 wherein a user places his/her finger on the touch sensitive user interface or pad, which as detailed above is enabled to determine presence of a user's finger, or read a user's finger image by optics, heat, electronics, or any known method. The computing device then automatically gathers finger image data at block 52. To conserve power and maintain a fast response rate for the computing device first recognizing that a user is present at block 50, the computing device may rely on non-imaging heat or pressure sensing to determine that a user is present. Once so determined, the more data-intensive step of gathering finger image data at block 52 may then be executed. Whether employing such a power saving feature or continuously scanning for a user's finger image even when a user is not in contact with the touch-sensitive interface 20, FIG. 4 distinguishes between first receiving a user input at the touch-sensitive pad (however sensed) and gathering the user's finger image or other biometric data. At block 54, the processor of the computing device compares the gathered finger image data against a database of authorized users. That database is stored in a computer readable media such as the memory 28 elsewhere described. It is anticipated that some embodiments may not require an exact bit-by-bit match to determine whether a user is authorized or not since some bits may reasonably exhibit error, but some threshold of correspondence between the gathered finger image data and information in the database representing one authorized user must be achieved before a positive decision is reached. That decision is made at block 56.

If the decision from block 56 at the computing device is that the user is not authorized, block 58 indicates that the visual cursor is not activated on the graphical display screen. If instead the decision at block 56 is positive, then block 60 applies and the visual cursor is initiated/activated at the graphical display screen. Note as above that there may be multiple different cursors for different data entry or navigation devices; the cursor referenced by FIG. 4 relates only to that corresponding to user entries sensed at the touch-sensitive pad 20.

Block 62 is then automatically executed, where the computing device senses the presence of the authorized user's finger. As above, this may be a continuous sensing or periodic, and may include sensing of the user's finger image itself or of some other type of sensory data that consumes less power and processing power, such as sensing only heat generated by a user's finger on the touch-sensitive pad, sensing pressure on the pad, optically sensing proximity of the user's finger to the pad, or any other such alternative means. However a user's presence at the touch-sensitive pad is measured, a decision is made at block 64. If the authorized user is determined to have withdrawn from contact with the surface of the touch-sensitive pad 20, the cursor is disabled from the graphical display screen at block 66. If instead the authorized user is determined to have maintained contact with the touch-sensitive pad (either continuously or within the periodic presence-monitoring period), then a first feedback loop 68 becomes active and the computing device continuously or periodically re-executes the steps of blocks 62 and 64. If the decision at block 64 is that the authorized user is still present, the computing device also senses at block 70 movement of the authorized user's finger at the touch-sensitive pad, and at block 72 it moves the visual cursor in correspondence with the authorized user's finger movement sensed at block 70. A second feedback loop 74 enables the computing device to move the cursor according to movement sensed at the touch-sensitive pad without regard to any delay period between sensing done at clock 62 and resultant decision at block 64. Note that the first feedback loop 68 is active simultaneous with the second feedback loop 74; they operate in parallel but are both terminated when the decision at block 64 is NO.

The particularly illustrated process steps may be re-arranged somewhat to more efficiently adapt to a particular embodiment. For example, the second feedback loop 74 as well as process blocks 70-72 may be wholly contained within the first feedback loop 68 between blocks 62 and 64, so long as the cursor remains sufficiently responsive to user inputs such as by employing a very short period over which the first feedback loop 68 operates to sense a user's presence at a touch-sensitive pad 20.

The embodiments of this invention may be implemented by computer software executable by a data processor 24 of the mobile station 10 or other host computing device, or by hardware, or by a combination of software and hardware. Further in this regard it should be noted that the various blocks of the logic flow diagram of FIG. 4 may represent program steps, or interconnected logic circuits, blocks and functions, or a combination of program steps and logic circuits, blocks and functions.

Specifically, the invention may be embodied in computer program code, a program of machine-readable instructions that are tangibly embodied on an information bearing medium and executable by a digital data processor to perform actions directed toward actuating a cursor in correspondence with a user input. These actions include determining that a user initiates contact with a touch sensitive interface, gathering user biometric data from the touch-sensitive interface, and determining from the biometric data whether the user is authorized. If in fact it is determined that the user is authorized, then the program enables or commands activation of a visual cursor at a graphical display interface, and causes the visual cursor to move in correspondence with movement sensed at the touch-sensitive user interface. The program also continuously or periodically determines whether the user remains in contact with the touch-sensitive interface. When it is determined that the user no longer remains in contact with the touch-sensitive interface, the program causes the visual cursor to be removed from the graphical display interface. The computer program may also enable various rolling motions to cause a highlight/select and/or an execute command to initiate for a data field coincident at the graphical display with the visual cursor, as detailed above. Also as above, the computer program may operate with one type of data for determining whether the user remains in contact with the touch-sensitive interface (such as non-imaging data) that is different in type from the (imaging) biometric data gathered for user authentication.

The memory or memories 28 may be of any type suitable to the local technical environment and may be implemented using any suitable data storage technology, such as semiconductor-based memory devices, magnetic memory devices and systems, optical memory devices and systems, fixed memory and removable memory. The processor 24 may be of any type suitable to the local technical environment, and may include one or more of general purpose computers, special purpose computers, a single or interconnected group of microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects of the invention may be implemented in hardware (e.g., graphical display 14 and touch-sensitive interface 20), while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate. Programs, such as those provided by Synopsys, Inc. of Mountain View, Calif. and Cadence Design, of San Jose, Calif. automatically route conductors and locate components on a semiconductor chip using well-established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It is noted that the teachings of the present invention may be extended to any computing device having a touch-sensitive user interface 20 and a graphical display screen 14. Personal computers, PDAs, mobile stations, laptop and palmtop computers, as well as special purpose computers such as inventory entry devices and RFID readers can be adapted with the present invention to effect additional user security as well as a convenient display for authorized users.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

1. A method comprising:
receiving a user input at a touch-sensitive user interface;
responsive to the receiving, automatically recognizing a user from biometric data gathered at the touch-sensitive user interface;
responsive to recognizing; automatically activating a visual cursor at a graphical display;
sensing movement of the user input across the touch-sensitive user interface and moving the visual cursor across the graphical display in correspondence with the sensed planar movement; and
automatically removing the visual cursor from the graphical display when a user input is no longer sensed at the touch-sensitive user interface.

2. The method of claim 1 further comprising, after automatically removing the visual cursor from the graphical display:
receiving a second user input at a touch-sensitive user interface within a prescribed period of time after the user input is no longer sensed; and
re-activating the visual cursor at a last position on the graphical display;

3. The method of claim 1 further comprising, following automatically activating, sensing a first rolling movement of the user input at the touch-sensitive user interface and actuating a select command for a data field that is coincident on the graphical display with the visual cursor.

4. The method of claim 3 further comprising, following automatically activating, sensing a second rolling movement of the user input at the touch-sensitive user interface and actuating an execute command for a data field that is coincident on the graphical display with the visual cursor.

5. The method of claim 1, wherein recognizing a user from biometric data comprises sensing a user's finger image and comparing the sensed finger image to a database of authorized user finger images.

6. The method of claim 5, further comprising continuously comparing the sensed finger image to the database and wherein the user input is no longer sensed at the touch-sensitive user interface when at least one comparison fails.

7. The method of claim 1, further comprising continuously sensing the user input at the touch-sensitive user interface, and wherein the user input is no longer sensed at the touch-sensitive user interface when a user input is not continuously sensed.

8. The method of claim 1, wherein automatically removing the visual cursor from the graphical display comprises gradually fading the cursor.

9. A program of machine-readable instructions, tangibly embodied on an information bearing medium and executable by a digital data processor, to perform actions directed toward actuating a cursor in correspondence with a user input, the actions comprising:
determining that a user initiates contact with a touch sensitive interface;
gathering user biometric data from the touch-sensitive interface;
determining from the biometric data whether the user is authorized;
only if the user is authorized, then:
activating a visual cursor at a graphical display interface;
sensing movement at the touch-sensitive interface and moving the visual cursor in correspondence therewith;
continuously or periodically determining whether the user remains in contact with the touch-sensitive interface; and
removing the visual cursor from the graphical display interface when it is determined that the user no longer remains in contact with the touch-sensitive interface.

10. The program of claim 9, wherein sensing movement at the touch-sensitive interface and moving the visual cursor in correspondence therewith comprises sensing a rolling movement at the touch-sensitive interface and actuating a select command for a data field coincident at the graphical display with the visual cursor.

11. The program of claim 9, wherein sensing movement at the touch-sensitive interface and moving the visual cursor in correspondence therewith comprises sensing a rolling movement at the touch-sensitive interface and actuating an execute command for a data field coincident at the graphical display with the visual cursor.

12. The program of claim 9, wherein the user biometric data comprises a finger image and determining from the biometric data whether the user is authorized comprises comparing the gathered finger image to a database of authorized user finger images.

13. The method of claim 9, wherein continuously or periodically determining whether the user remains in contact with the touch-sensitive interface operates with data of a different type than the said biometric data.

14. A device comprising:
a touch-sensitive user interface adapted to gather user biometric data;
a graphical display screen;
a computer readable medium on which is stored user biometric data; and
a processor coupled to the touch-sensitive user interface, the graphical display screen, and the computer readable medium, said processor for:
comparing user biometric data gathered at the touch-sensitive user interface to the stored user biometric data;
initiating display of a cursor at the graphical display screen if the comparing is positive;
determining continuously or periodically that an authorized user remains in contact with the touch-sensitive user interface, and
disabling the display of the cursor at the graphical display screen when it is determined that the user no longer remains in contact with the touch-sensitive user interface.

15. The device of claim 14, wherein determining continuously or periodically that an authorized user remains in contact with the touch-sensitive user interface uses data other than biometric data.

16. The device of claim 14, further comprising, after initiating display of the cursor and prior to disabling:
moving the displayed cursor about the graphical display screen in correspondence with sensed movement at the touch-sensitive user interface.

17. The device of claim 15, wherein the processor operates to determine that an authorized user remains in contact with the touch-sensitive user interface simultaneously with moving the displayed cursor about the graphical display screen in correspondence with sensed movement at the touch-sensitive user interface.

18. The device of claim 14 further comprising a battery coupled to the processor.

19. The device of claim 18 comprising a mobile station.

20. The device of claim 14, further comprising a computer software program embodied on the computer readable medium, said computer software program for directing the processor to display the said cursor at the graphical display screen according to a first image, and for directing the processor to display at the graphical display screen a second cursor from an input device separate from the touch-sensitive screen according to a second image.

21. An apparatus comprising:
means for receiving a user input at a user interface;
means, responsive to receiving for recognizing a user from biometric data gathered at the user input;
means, responsive to recognizing for activating a visual cursor at a graphical display;
means for sensing a planar movement of the user input at the user interface and moving the visual cursor across the graphical display in correspondence with the sensed planar movement; and
means for removing the visual cursor from the graphical display when the user input is no longer sensed at the user interface.

22. The apparatus of claim 21, wherein:
the means for receiving and means for sensing comprises a touch sensitive user interface; and
the means for recognizing and means for removing comprises a processor coupled to a memory and to the graphical display.
